(19) United States
(12) Patent Application Publication
(10) Pub. No.: US 2026/0268791 A1
(43) Pub. Date: Sep. 10, 2026

(54) FLIGHT-CABIN TRAINING APPARATUS

(71) Applicant: AeroMed Dynamics LLC, Stephenville, TX (US)

(72) Inventor: Truxton Fox, Granbury, TX (US)

(73) Assignee: AeroMed Dynamics LLC, Stephenville, TX (US)

(21) Appl. No.: 19/074,690

(22) Filed: Mar. 10, 2025

(51) Int. Cl. G09B 9/12

(52) U.S. Cl. CPC G09B 9/12

(57) ABSTRACT

A training apparatus configured to simulate conditions experienced by personnel in the cabin of an aircraft, such as medical personnel working in the cabin of an air ambulance includes a cabin section, a floor section, and a base section. A first pivot joint is disposed between the base and floor to enable lateral rotation of the cabin. A second pivot joint is disposed in the base to enable longitudinal rotation of the cabin. Linear actuators controlled by a microcontroller control the rotational position of the cabin to simulate flight conditions.

### BACKGROUND

This invention pertains generally to flight-crew training equipment. More specifically, the invention is directed to technology for simulating flight conditions experienced in an aircraft cabin compartment. In a primary embodiment, a simulator is configured for training medical personnel to work in the cabin of an air ambulance.

Personnel, such as transport paramedics and nurses, are routinely called upon to provide care to a patient in a mobile air ambulance. This can be a taxing environment as the aircraft moves in multiple rotational directions, subjecting the personnel to forces that would not typically be experienced in a ground-based vehicle. Training in such an environment can familiarize the personnel to the forces experienced in such an environment and enable them to better handle the forces, and the associated disorientation, to provide services in the aircraft.

### SUMMARY

An apparatus for training personnel to function in an air-borne environment includes a cabin having longitudinal and lateral rotational degrees of freedom. By selectively rotating the cabin longitudinally and/or laterally, personnel in the cabin experience orientations and changes in orientation that are similar to those they might experience during flight.

An exemplary flight-cabin training apparatus includes a base assembly, a floor assembly, and a cabin assembly. The base assembly includes upper and lower components that are pivotably attached to each other at one end to provide a first rotational degree of freedom between the upper and lower components: the components can rotate about a pivot joint such that their relative position changes rotationally. The floor assembly is pivotably attached to the upper component of the base assembly to provide a second rotational degree of freedom between the upper component of the base assembly and the floor assembly: the floor and upper component can rotate about a pivot joint such that their relative position changes rotationally. The cabin is attached to the floor assembly, creating a bottom-to-top stack of: base, floor, cabin. The first and second rotational degrees of freedom differ, and may be orthogonal. The first rotational degree of freedom may be longitudinal, allowing the cabin to pivot front-to-back. The second rotational degree of freedom may be lateral, allowing the cabin to pivot left-to-right.

The apparatus further includes a set of linear actuators (e.g., pneumatic, hydraulic, or electric actuators). These actuators are positioned so that they can be selectively extended or retracted to change the cabin's position about one or both rotational axes. A first actuator (or subset of actuators) may be positioned between the upper and lower components of the base such that extending the actuator(s) will cause one end of the components to separate while the pivot joint at the other end keeps that end together, resulting in the upper component pivoting relative to the lower component about the pivot joint (analogous to a clam shell opening). A second actuator (or subset of actuators) may be positioned between the upper component of the base and the floor such that extending an actuator(s) (and, in some embodiments, contemporaneously retracting other actuator(s)) causes the floor and attached cabin to pivot relative to the upper component. Through selective extension, retraction, or maintenance of each actuator in the set of actuators, the cabin may be selectively rotated about one or both pivot joints.

### BRIEF DESCRIPTION OF THE DRAWINGS

These and other features, aspects, and advantages of the present invention will become better understood with reference to the following description, appended claims, and accompanying drawings where:

FIGS. 1A-1E are various views illustrating an exemplary embodiment of simulator frame.

FIGS. 2A-2D are various views illustrating an exemplary embodiment of a base-floor assembly of a simulator frame.

FIGS. 3A-3C are various views illustrating an exemplary embodiment of a base assembly of a simulator frame.

FIG. 4 is a functional block diagram illustrating an exemplary control circuit for a simulator.

FIGS. 5A-5D are flow charts illustrating an exemplary algorithm for controlling the simulator.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

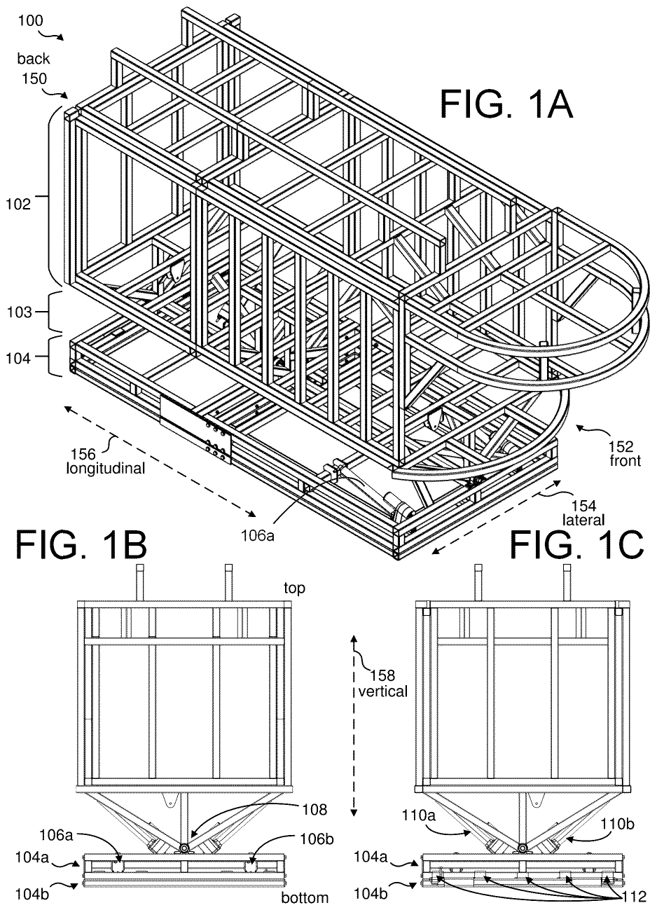

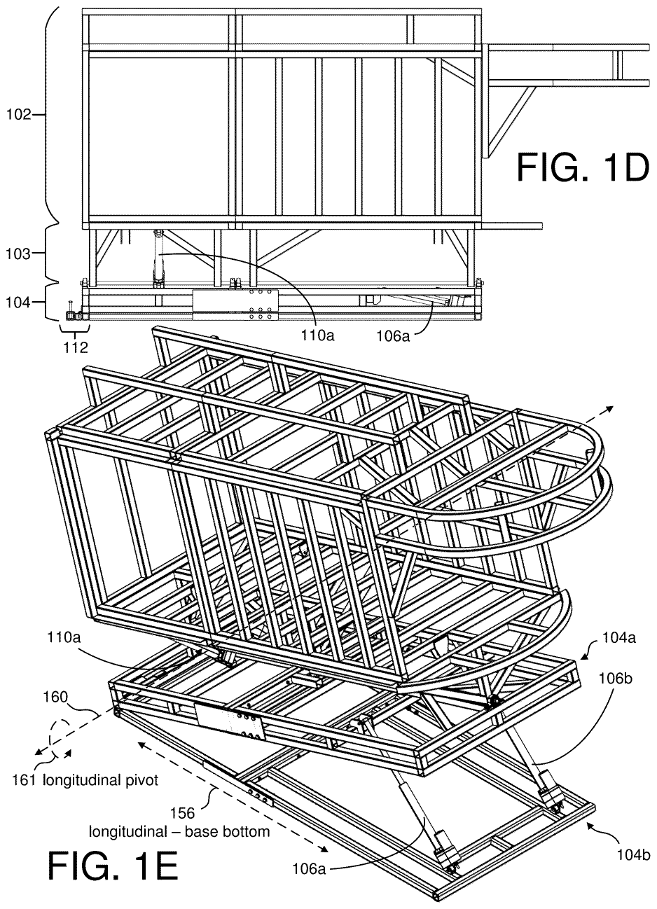

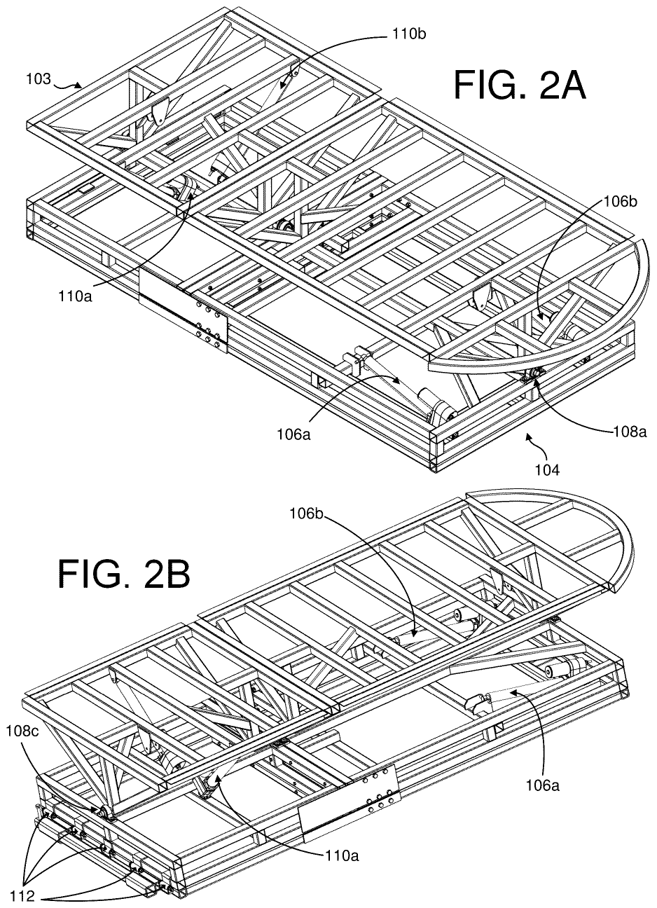

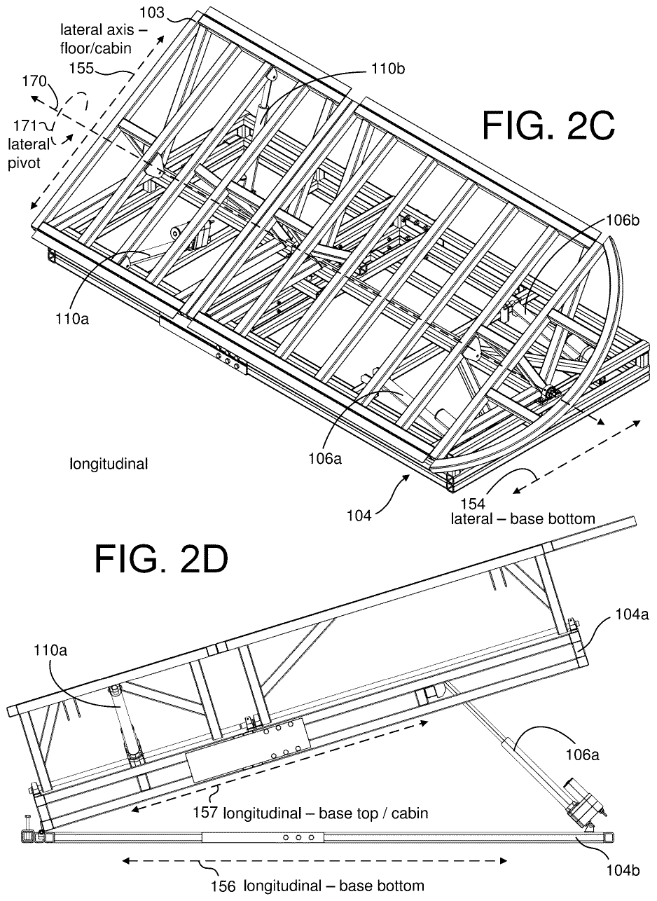

Reference directions “front,” “back,” “longitudinal,” “lateral,” “vertical,” and “horizontal” are used herein to denote axes and planes to describe embodiments of the invention. The “front” 152 and “back” 150 of the air-ambulance-cabin simulator 100 illustrated in FIG. 1A-3C are denoted in FIG. 1A. The “longitudinal” 156 and “lateral” 154 axes of the simulator 100 base bottom 104b are denoted with dashed arrows in FIGS. 1A, 1E, and 2D. Together, the “longitudinal” 156 and “lateral” 154 axes define the “horizontal” plane of the simulator 100 when the simulator is in the horizontal state. The “vertical” axis 158 is denoted with a dashed arrow in FIGS. 1B and 1C. The “longitudinal pivot” 161 rotational degree of freedom about a “longitudinal pivot” axis 160 is denoted with dashed arrows in FIG. 1E. The “lateral pivot” 171 rotational degree of freedom about a “lateral pivot” axis 170 is denoted with dashed arrows in FIG. 2C. As explained herein and illustrated, e.g., in FIG. 2D, the cabin's 102 “longitudinal” axis 157 may be varied with respect to the base bottom's 104b “longitudinal” axis 156. Also as explained herein and illustrated, e.g., in FIG. 2C, the cabin's 102 “lateral” axis 155 may be varied with respect to the base bottom's 104b “lateral” axis 154.

FIG. 1A is an isometric view of a frame of an exemplary embodiment of an air-ambulance-cabin simulator 100. The simulator 100 includes an upper cabin assembly 102 connected to a base assembly 104 via a floor assembly 103. As explained herein, the base assembly 104 includes at least two pivot joints 108, 112 to enable at least two rotational degrees of freedom 161, 171 for the position of the cabin assembly 102. As explained herein, the cabin assembly 102 is selectively positioned through use of a collection of electric actuators 106a, 106b, 110a, 110b to pivot the cabin 102 about the pivot joints 108, 112.

FIGS. 1B and 1C are, respectively, front and back views of the simulator 100. The base 104 includes a top component 104a and a bottom component 104b interconnected with a longitudinal pivot joint 112 (in this example, a series of hinges) defining a longitudinal pivot axis 160. The floor assembly 103 is connected to the base's top component 104a via a lateral pivot joint 108 defining a lateral pivot axis 170.

FIG. 1D is a side view of the simulator 100. Lateral actuators 110a, 110b control the position of the cabin 102 about the lateral pivot joint 108 (comprising, in this embodiment, a series of plain bearings 108a, 108b, 108c). Longitudinal actuators 106a, 106b control the position of the cabin about the longitudinal pivot join 112.

FIG. 1E is an isometric view of the simulator 100 with the longitudinal actuators 106a, 106b extended to pivot the cabin 102 up about the longitudinal pivot axis 160. In this position, the base's top component 104a is pivoted about the longitudinal pivot axis 160 with respect to the base's bottom component 104b. The longitudinal actuators 106a, 106b are connected at one end (e.g., the rod end) to the top component 104a near the front and at the other end (e.g., the base end) to the bottom component 104b near the front. The top 104a and bottom 104b components are connected at their back ends via the longitudinal pivot joint 112 such that extension of the linear longitudinal actuators 106a, 106b separate the front ends of the top 104a and bottom 104b components while the back ends of these components 104a, 104b remain connected via the pivot joint 112. Selective control of the longitudinal actuators 106a, 106b may be used to simulate different aircraft longitudinal rotational positions.

FIGS. 2A-2C are various isometric views illustrating the base 104 and floor 103 assemblies. FIG. 2A is a front perspective and FIG. 2B is a rear perspective, both illustrate the floor 103 in a horizontal state (i.e., aligned substantially parallel to the base bottom 104b). FIG. 2C is a front perspective illustrating the floor 103 in a laterally tilted state. In this state, a lateral linear actuator 110b is extended to cause the floor 103 to pivot about the lateral pivot axis 170. The floor 103 is connected to the base top 104a with a lateral pivot joint 108 (instantiated in this embodiment as a collection of three plain bearings 108a, 108b, 108c disposed along the length of the base 104 and engaged with a shaft (or shafts) disposed along the length of the floor 103). In this exemplary simulator 100, two lateral actuators 110a, 110b work in concert to tilt the floor 103 about the lateral pivot axis 170: a first actuator 110a is extended and the other 110b is retracted to tilt the floor 103 in one direction and the first actuator 110a is retracted and the other 110b is extended to tilt the floor 103 in another direction.

FIG. 2D is a side view illustrating the floor 103 in a longitudinally tilted state. (As described above with reference to FIG. 1E.)

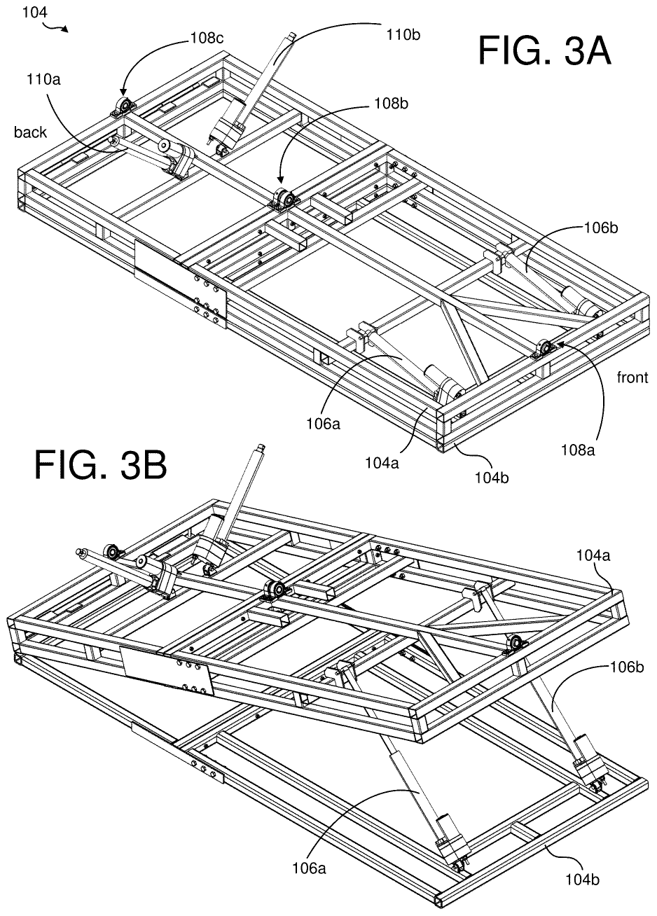

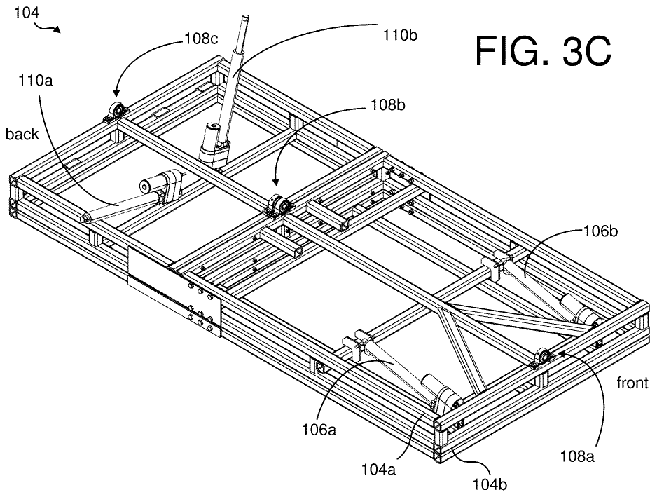

FIG. 3A is an isometric view of the exemplary base 104 in a horizontal state. The longitudinal actuators 106a, 106b are connected at one end (e.g., the rod end) to the top component 104a near the front and at the other end (e.g., the base end) to the bottom component 104b near the front. The actuators 106a, 106b are depicted in a retracted state.

FIG. 3B is an isometric view of the exemplary base 104 in a longitudinally tilted/laterally horizontal state. The longitudinal actuators 106a, 106b are extended to pivot the base's upper component 104a about the longitudinal pivot joint 112, resulting in the upper component 104a (and any attached floor and cabin) being tilted relative to the lower component 104b along the longitudinal axis of the simulator.

FIG. 3C is an isometric view of the exemplary base 104 in a longitudinally horizontal/laterally tilted state. One lateral actuator 110b is extended and the other 110a is retracted to pivot any attached floor and cabin about the lateral pivot joint 108, resulting in the attached floor and cabin being tilted relative to the base 104 along the lateral axis of the simulator.

The longitudinal 106a, 106b and lateral 110a, 110b actuators work in concert to provide various states of longitudinal and lateral rotation of the cabin 102.

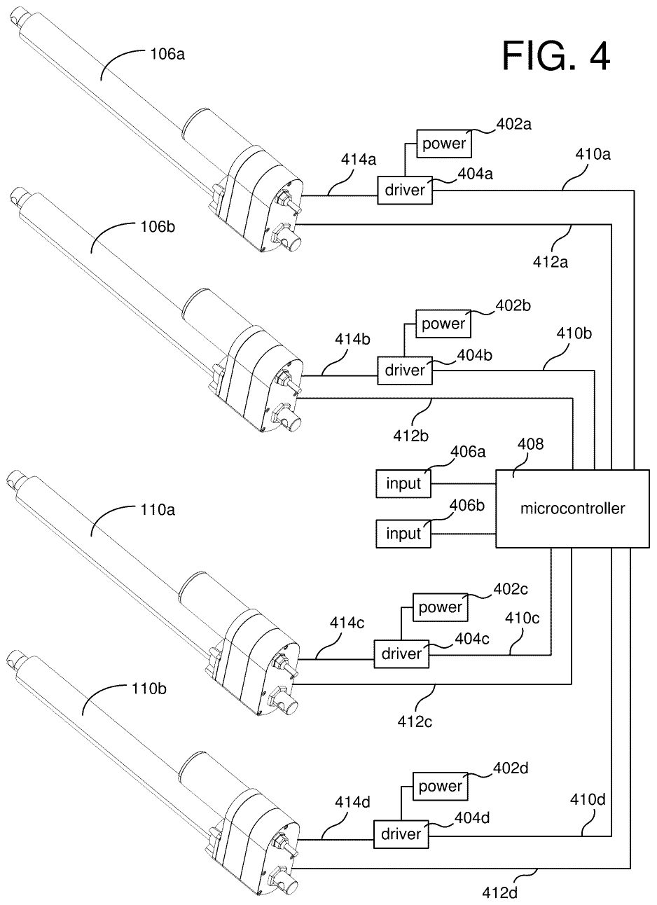

FIG. 4 is a functional block diagram illustrating an exemplary circuit for controlling the actuators 106a, 106b, 110a, 110b of the air-ambulance-cabin simulator 100. A microcontroller 408 is connected to actuator-motor-driver circuits 404a, 404b, 404c, 404d through a driver-communication bus 410a, 410b, 410c, 410d. Each actuator-motor-driver circuit 404a, 404b, 404c, 404d selectively connects power 402a, 402b, 402c, 402d to a motor of an actuator 106a, 106b, 110a, 110b through a power bus 414a, 414b, 414c, 414d as instructed by the microcontroller 408. The microcontroller 408 is also connected to actuator electronics through a communication bus 412a, 412b, 412c, 412d. The state of an actuator 106a, 106b, 110a, 110b is set by the microcontroller through signals to the actuator-motor-driver circuits 404a, 404b, 404c, 404d. The actuator 106a, 106b, 110a, 110b settings are varied over time to simulate conditions that may be experienced in operation of an air ambulance. This may be done manually through an input 406a such as a keypad or joystick: a user may press a button(s) or move a joystick to the place the actuators in different settings and thereby vary the lateral and/or longitudinal tilt positions of the cabin 102 to manually simulate flight conditions. The actuator settings may be provided in a file or stream through an input 406b such as a memory card or network interface. For example, a user may provide data as a series of actuator states that correspond to a predetermined simulated flight condition.

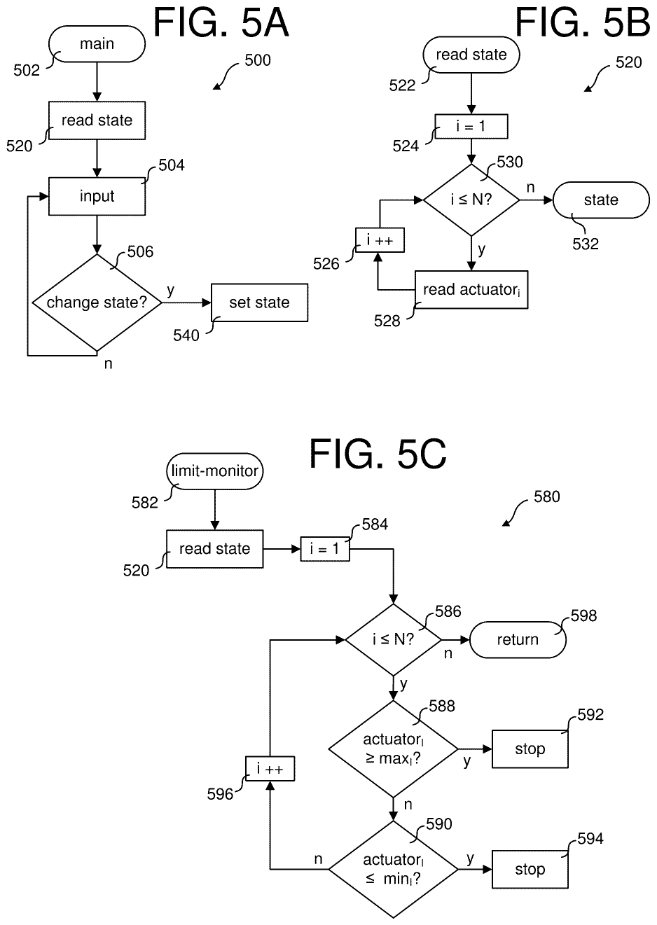

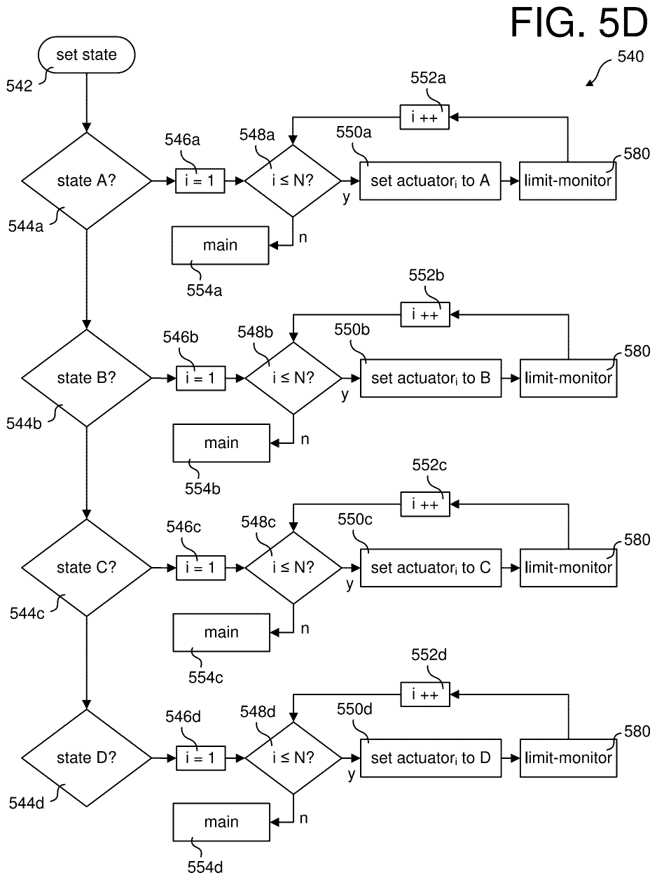

FIGS. 5A-5D are flow charts illustrating an exemplary algorithm 500 for controlling the actuators 106a, 106b, 110a, 110b of the air-ambulance-cabin simulator 100. The flow 500 may be implemented by the microcontroller 408 described with reference to FIG. 4.

As illustrated in FIG. 5A, the controller enters 502 the main flow 500 then reads 520 the state of the system, reads input 504 (e.g., button states or data stream), and determines 506 whether the system is to change state. If the system is instructed to change state, the new state is set 540. If the system is not instructed to change state, it continues to process input 504/506.

As illustrated in FIG. 5B, the controller may enter 522 a process 520 to read the state of the system. The controller reads 528 the state of each actuator in the system. This exemplary process 520 is for a system with N actuators (N=4 for the system described with reference to FIG. 4). Thus, the controller may loop through the N actuators reading each actuator serially or it may read the N actuators in parallel (or some combination thereof). (As depicted, a serial-read process may use a loop-control variable 524 incremented 526 after each read 528 until the state of all the actuators have been read 530, at which point the state of the system has been determined 532.) The state of an actuator may include an indication of the extent to which it is extended. For example, a potentiometer may provide a voltage signal indicative of the distance the actuator rod is extended. Similarly, limit switches may provide indications of the whether the actuator is fully extended or fully retracted.

As illustrated in FIG. 5C, the controller may enter 582 a process 580 to monitor the actuators to disable any change of state that may move an actuator outside of predetermined limits. For example, for any state each actuator may have “max” and “min” value associated with it that correspond to the maximum and minimum extensions of the actuator in that state, respectively. For each actuator, the controller may determine if the state of the actuator is at or over its maximum extension 588 and, if so, stops any extension of the actuator 592. Similarly, the controller may determine if the state of the actuator is at or below its minimum extension 590 and, if so, stops any retraction of the actuator 594. The controller may loop through the N actuators to monitor/stop each actuator serially or it may do so in parallel (or some combination thereof). (As depicted, a serial process may use a loop-control variable 584 incremented 596 after each check 588/590 until the state of all the actuators have been checked 586, at which point the controller returns 598 to other processes in the algorithm.)

As illustrated in FIG. 5D, the controller may enter 542 a process 540 to change the state of the system. In this example, there are four possible states, A, B, C, D, but more or fewer states may be implemented. Each state corresponds to a set of actuator settings to thereby set the position of the of the simulator. For example, for the four-actuator simulator 100 depicted in FIG. 1A: State A may correspond to a horizontal position (as depicted in FIG. 1A), in which the longitudinal actuators 106a, 106b are fully retracted and the lateral actuators 110a, 110 b are 50% extended. This state may be represented in set notation as {0, 0, 0.5, 0.5}, where the first element represents the extension of the left longitudinal actuator 106a as a percentage (in decimal) of fully extended, the second element represents the extension of the right longitudinal actuator 106b as a percentage of fully extended, the third element represents the extension of the left lateral actuator 110a as a percentage of fully extended, the fourth element represents the extension of the right lateral actuator 110b as a percentage of fully extended. State B may correspond to a longitudinal-full-tilt position (as depicted in FIG. 1E), in which the longitudinal actuators 106a, 106b are fully extended and the lateral actuators 110a, 110 b are 50% extended. This state may be represented as {1, 1, 0.5, 0.5}. State C may correspond to a left-lateral-full-tilt position (as depicted in FIG. 2C), in which the longitudinal actuators 106a, 106b are fully retracted, the left lateral actuator 110a is fully retracted, and the right lateral actuator 110b is fully extended. This state may be represented as {0, 0, 0, 1}. State D may correspond to a right-lateral-full-tilt position: {0, 0, 1, 0}. Other states may correspond to other rotational positions, e.g., {1, 1, 0, 1} for a longitudinal-left-full-tilt position and {1, 1, 1, 0} for a longitudinal-right-full-tilt position.

In the process 540 to set the state of the system, the controller determines the target state, then sets each actuator in the system to retract or extend the individual actuators as appropriate to place the simulator in that state. For example, if the four-actuator simulator 100 is in a horizontal position, {0,0,0.5,0.5}, and the target state is a longitudinal-full-tilt position, {1, 1, 0.5, 0.5}, the controller will set the left 106 a and right 106b longitudinal actuators to extend, and monitor the actuator states to stop the extension when 100% extension is reached. If a longitudinal-left-full-tilt position {1, 1, 0, 1} is the next new target state, the controller will set the left lateral actuator 110a to retract and the right lateral actuator 110b to extend, and monitor the actuator states to stop the retraction/extension when 0% and 100% extension is reached on the left 110 a and right 110b lateral actuators, respectively. The controller determines the target state 544a, 544b, 544c, 544d then sets 550a, 550b, 550c, 550d each actuator to extend or retract or maintain as appropriate to achieve the target state. The controller may loop through the N actuators to set each actuator serially or it may do so in parallel (or some combination thereof). (As depicted, a serial process may use a loop-control variable 546a, 546b, 546c, 546d incremented 552a, 552b, 552c, 552d after the actuator is set 550a, 550b, 550c, 550d until the state of all the actuators have been set 548a, 548b, 548c, 548d, at which point the controller returns 554a, 554b, 554c, 554d to other processes in the algorithm.) To determine whether to extend or retract or maintain a given actuator, the controller may compare the current state of the actuator to the target state of the actuator.

As described herein, a simulator having longitudinal and lateral rotational degrees of freedom may be selectively positioned rotationally using a set of actuators controlled to rotate the simulator into the target position by appropriately extending, retracting, or maintaining each actuator in the set. The simulator may be placed in a time series of rotational positions to simulate the change in orientation that one might experience, e.g., in the cabin of an air ambulance in flight. The time series may be predetermined and provided to a controller by, e.g., a data stream. The time series may be manually provided by a user through, e.g., manipulation of a button, keypad, or joystick.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A flight-cabin training apparatus comprising:
(a) a base assembly comprising:
(i) a lower base component having a first end and a second end,
(ii) an upper base component having a first end, a second end, and a top,
(iii) a first pivot joint pivotably connecting the lower base component to the upper base component at the first end of the lower base component and the first end of the upper base component, wherein the first pivot joint defines a first pivot axis;
(b) a floor assembly having a bottom and a top;
(c) a second pivot joint pivotably connecting the floor assembly to the upper base component at the bottom of the floor assembly and the top of the upper base component, wherein the second pivot joint defines a second pivot axis;
(d) a cabin assembly connected to the top of the floor assembly;
(e) a first linear actuator having a first end and a second end, wherein:
(i) the first end of the first linear actuator is connected to the upper base component and the second end of the first linear actuator is connected to the lower base component,
(ii) the first linear actuator is disposed toward the second end of the lower base component and the second end of the upper base component, and
(iii) the first linear actuator is configured to selectively separate the second
end of the lower base component and the second end of the upper base component thereby causing the upper base component to pivot relative to lower base component about the first pivot axis; and
(f) a second linear actuator having a first end and a second end, wherein:
(i) the first end of the second linear actuator is connected to the floor assembly and the second end of the second linear actuator is connected to the upper base component, and
(ii) the second linear actuator is configured to selectively pivot the floor assembly relative to the upper base component about the second pivot axis.

2. The flight-cabin training apparatus of claim 1 further comprising a third linear actuator having a first end and a second end, wherein:
(a) the first end of the third linear actuator is connected to the floor assembly and the second end of the third linear actuator is connected to the upper base component, and
(b) the third linear actuator is configured to selectively pivot the floor assembly relative to the upper base component about the second pivot axis.

3. The flight-cabin training apparatus of claim 1 further comprising a fourth linear actuator having a first end and a second end, wherein:
(a) the first end of the fourth linear actuator is connected to the upper base
component and the second end of the fourth linear actuator is connected to the lower base component,
(b) the fourth linear actuator is disposed toward the second end of the lower base component and the second end of the upper base component, and
(c) the fourth linear actuator is configured to selectively separate the second end of the lower base component and the second end of the upper base component thereby causing the upper base component to pivot relative to lower base component about the first pivot axis.

4. The flight-cabin training apparatus of claim 1 wherein the first linear actuator has a first motor and the second linear actuator has a second motor, the apparatus further comprising:
(a) a first power supply connected to the first motor;
(b) a second power supply connected to the second motor; and
(c) a microcontroller configured to:
(i) selectively activate the first motor to extend or retract the first linear actuator; and
(ii) selectively activate the second motor to extend or retract the second linear actuator.

5. The flight-cabin training apparatus of claim 4 furthering comprising a first motor driver and a second motor driver, wherein:
(a) the first power supply is connected to the first motor through the first motor driver; and
(b) the second power supply is connected to the second motor through the second motor driver.

6. The flight-cabin training apparatus of claim 4 wherein the microcontroller is further configured to:
(a) determine a current state of the first linear actuator;
(b) determine a current state of the second linear actuator;
(c) determine a target state for the first linear actuator;
(d) determine a target state for the second linear actuator;
(e) determine a difference between the current state of the first linear actuator and the target state of the first linear actuator;
(f) determine a difference between the current state of the second linear actuator and the target state of the second linear actuator;
(g) determine whether to extend or retract the first linear actuator using the difference between the current state of the first linear actuator and the target state of the first linear actuator; and
(h) determine whether to extend or retract the second linear actuator using the difference between the current state of the second linear actuator and the target state of the second linear actuator.

7. The flight-cabin training apparatus of claim 4 wherein the microcontroller is further configured to:
(a) determine whether the first linear actuator is extended to or beyond a predetermined first maximum level;
(b) determine whether the second linear actuator is extended to or beyond a predetermined second maximum level;
(c) determine whether the first linear actuator is extended to or below a predetermined first minimum level;
(d) determine whether the second linear actuator is extended to or below a predetermined second minimum level;
(e) disable extension of the first linear actuator if the first linear actuator is extended to or beyond a predetermined first maximum level;
(f) disable retraction of the first linear actuator if the first linear actuator is extended to or below a predetermined first minimum level;
(g) disable extension of the second linear actuator if the second linear actuator is extended to or beyond a predetermined second maximum level; and
(h) disable retraction of the second linear actuator if the second linear actuator is extended to or below a predetermined second minimum level.

8. The flight-cabin training apparatus of claim 6 wherein the microcontroller is further configured to receive an input indicative of a target state for the first linear actuator and a target state for the second linear actuator.

9. The flight-cabin training apparatus of claim 8 wherein the input includes at least one of the group consisting of a data file, a data stream, a button signal, a keyboard signal, and a keypad signal.

10. The flight-cabin training apparatus of claim 9 wherein the data file includes a time-series of values indicative of target states for first linear actuator and the second linear actuator.

11. The flight-cabin training apparatus of claim 6 wherein the microcontroller is further configured to receive an input indicative of a current state of the first linear actuator and a current state of the second linear actuator.

12. The flight-cabin training apparatus of claim 11 wherein the input includes at least one of the group consisting of a first value indicative of a state of a potentiometer in the first linear actuator, a second value indicative of a state of a potentiometer in the second linear actuator, a third value indicative of a state of a lower-limit switch in the first linear actuator, a fourth value indicative of a state of an upper-limit switch in the first linear actuator, a fifth value indicative of a state of a lower-limit switch in the second linear actuator, and a sixth value indicative of a state of an upper-limit switch in the second linear actuator.

13. The flight-cabin training apparatus of claim 1 further comprising a means for setting a state of extension of the first linear actuator and a state of extension of the second linear actuator.

14. The flight-cabin training apparatus of claim 1 further comprising a means for determining the state of extension of the first linear actuator and the state of extension of the second linear actuator.

15. The flight-cabin training apparatus of claim 1 further comprising a means for controlling a state of extension of the first linear actuator and a state of extension of the second linear actuator based on input indicative of a target state and input indicative of a current state.
